(19) United States
(12) Patent Application Publication
(10) Pub. No.: US 2002/0085266 A1
(43) Pub. Date: Jul. 4, 2002

(54) Wavelength converter with an impedance matched electro-absorption modulator pair

(76) Inventor: Xiaotian Steve Yao, Diamond Bar, CA (US)

Correspondence Address: HOGAN & HARTSON L.L.P., 500 S. GRAND AVENUE, SUITE 1900, LOS ANGELES, CA, 90071-2611, US

(21) Appl. No.: 09/996,165

(22) Filed: Nov. 27, 2001

Related U.S. Application Data
(60) Provisional application No. 60/253,292, filed on Nov. 27, 2000.

(51) Int. Cl. G02F 1/35; G02F 1/355

(52) U.S. Cl. 359/326

(57) ABSTRACT

A wavelength converter including a chip having formed therein a first electro-absorption modulator biased as a photodetector, and a second electro-absorption modulator biased as a modulator electrically coupled to the first electro-absorption modulator. The first electro-absorption modulator detects an input signal at wavelength λ1 and generates an electrical signal to control the second electro-absorption modulator's modulation of light from a wave source at wavelength λ2.

### CROSS-REFERENCE TO RELATED APPLICATION

The present application claims priority under 35 U.S.C. § 119(e) to U.S. Provisional Application No. 60/253,292, filed on Nov. 27, 2000, which is expressly incorporated by reference as though fully set forth herein.

### BACKGROUND OF THE INVENTION

1. Area of the Art

The present invention relates to devices and methods for wavelength conversion, and in particular, to wavelength conversion utilizing electro-absorption modulators.

2. Description of the Prior Art

Currently, researchers and commercial establishments are investigating two types of wavelength converters. One type of wavelength converter utilizing SOA (semiconductor optical amplifier) interferometers is shown in FIG. 1. In FIG. 1, a signal at wavelength λ2 is input to both SOA interferometers. Also, input data of wavelength λ1 is input to one of the SOA interferometers. The output signal from both SOA interferometers are then combined and passed through a filter which outputs output data at wavelength λ2. This type of wavelength converter has the disadvantage of requiring precision microdevice fabrication. Also, this type of wavelength converter is highly susceptible to temperature variations.

The other type of wavelength converter utilizes opto-electronic conversion. An example of a wavelength converter utilizing opto-electronic conversion is shown in FIG. 2. As indicated in FIG. 2, the optical input data stream at wavelength λ1 is first input to a photodetector. The electrical signal output from the photodetector is then amplified, re-shaped, and may be re-timed before the electrical signal is input to the modulator of a transmitter. The modulator modulates a signal at wavelength λ2 based on the electrical signal, and outputs output data at wavelength λ2. This type of wavelength converter requires extensive electrical amplification and thus is power consuming, expensive, and complicated. Because the impedances of the electronic circuits that comprise the wavelength converter are typically 50 Ω, both the photodetector and the modulator are impedance matched at 50 Ω, making the optical-to-electrical and the electrical-to-optical (OEO) conversions inefficient. In addition, it is difficult to integrate both the electronic and optic components on a single chip.

### SUMMARY OF THE INVENTION

Therefore, an object of the present invention is to provide a simple and low cost wavelength converter that can be implemented as a single chip device.

In one aspect of the present invention, a wavelength converter includes a chip having formed therein a first electro-absorption modulator biased as a photodetector, and a second electro-absorption modulator biased as a modulator electrically coupled to the first electro-absorption modulator.

It is understood that other embodiments of the present invention will become readily apparent to those skilled in the art from the following detailed description, wherein it is shown and described only embodiments of the invention by way of illustration of the best modes contemplated for carrying out the invention. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### DESCRIPTION OF THE FIGURES

FIG. 1 is a block diagram of a prior art wavelength converter utilizing SOA interferometers;

FIG. 2 is a block diagram of a prior art wavelength converter utilizing opto-electronic conversion;

FIG. 3 is a block diagram of a wavelength converter utilizing a pair of impedance matched electro-absorption modulators in accordance with an exemplary embodiment of the present invention;

FIG. 4 is a schematic diagram of an electrical circuit for the exemplary embodiment in FIG. 3;

FIG. 5 is a schematic diagram of an electrical circuit for the exemplary embodiment in FIG. 3; and

FIG. 6 is a block diagram of a wavelength converter utilizing a pair of impedance matched electro-absorption modulators in accordance with an exemplary embodiment of the present invention.

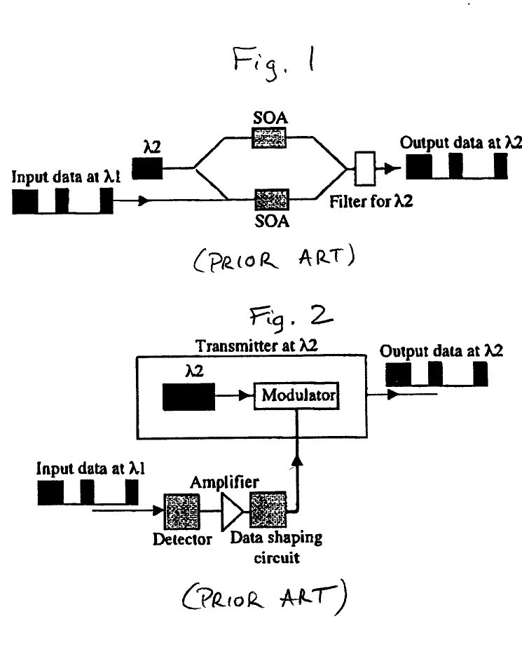

### DETAILED DESCRIPTION OF THE INVENTION

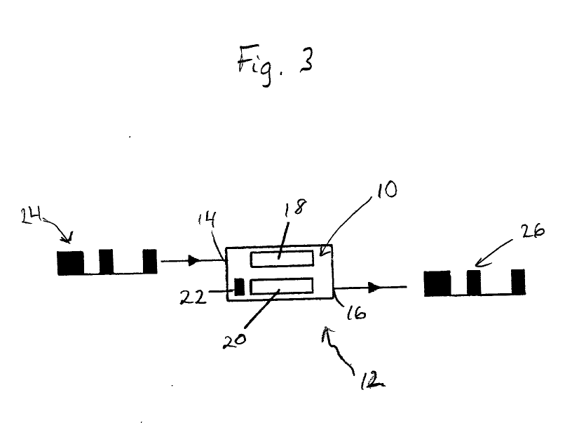

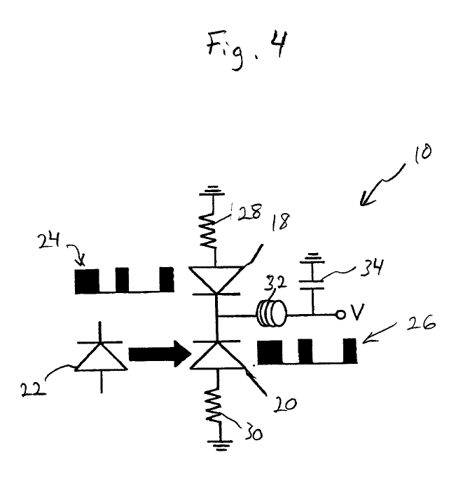

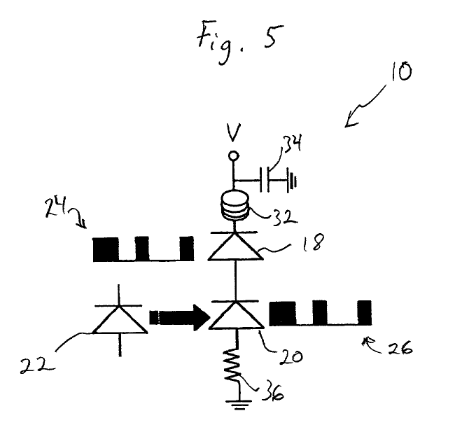

FIG. 3 is a block diagram that illustrates an exemplary embodiment of the present invention. In particular, FIG. 3 illustrates a wavelength converter 10 comprising a chip 12 having an input 14 and an output 16, within which is formed a closely spaced pair of electro-absorption modulators 18, 20. As shown in FIGS. 4 and 5, the first electro-absorption modulator 18 is biased as a photodetector and the second electro-absorption modulator 20 is biased for efficient modulation. The first and second electro-absorption modulators are directly connected to one another, for example by wire bonding. Also formed within the wavelength converter chip is a wave source 22 adjacent to the second electro-absorption modulator that emits a signal at wavelength λ2. The wave source may be, for example, a light emitting diode, a diode laser, or a tunable wave source. A tunable wave source provides for the advantage that the wavelength λ2 is variable, thus, providing for tuning of the wavelength converter. The wave source is preferably formed within the chip, but may be located off the chip.

In operation, optical input data 24 at wavelength λ1 enters the wavelength converter 10 at its input 14. The first electro-absorption modulator 18 receives the optical input data at wavelength λ1 and converts it into an electrical signal which is input to the second electro-absorption modulator 20 as a control signal. Also, the wave source 22 generates a signal at wavelength λ2 that is coupled into the second electro-absorption modulator. The second electro-absorption modulator modulates the signal from the wave source at wavelength λ2 with the electrical control signal and generates an output data signal 26 at wavelength λ2 which leaves the wavelength converter via the output 16.

FIG. 4 is a schematic diagram that illustrates an electrical circuit for the embodiment of FIG. 3. In particular, FIG. 4 illustrates the wavelength converter 10 including the first electro-absorption modulator 18 biased as a photodetector electrically connected to the second electro-absorption modulator 20 biased as a modulator. A first resistor 28 is electrically connected between the first electro-absorption modulator and ground potential. Similarly, a second resistor 30 is electrically connected between the second electro-absorption modulator and ground potential. An inductor 32 is electrically connected between both the first and second electro-absorption modulators and a voltage potential V. A capacitor 34 is electrically connected between the voltage potential V and ground potential.

FIG. 5 is a schematic diagram that illustrates another electrical circuit for the embodiment of FIG. 3. In particular, FIG. 5 illustrates the wavelength converter 10 including the first electro-absorption modulator 18 biased as a photodetector electrically connected to the second electro-absorption modulator 20 biased as a modulator. The inductor 32 is electrically connected between the voltage potential V and the first electro-absorption modulator. The capacitor 34 is electrically connected between the voltage potential V and ground potential. A third resistor 36 is electrically connected between the second electro-absorption modulator and ground potential.

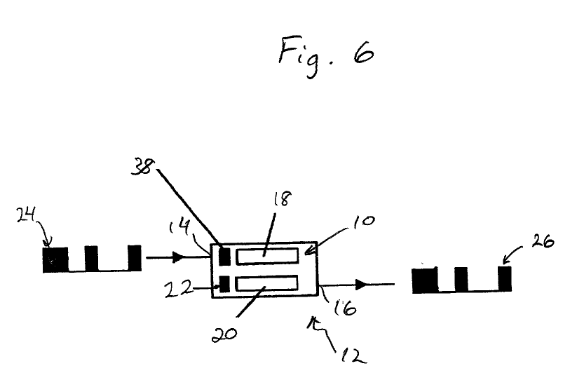

FIG. 6 is a block diagram that illustrates an exemplary embodiment of the present invention. This embodiment is similar to the embodiment of FIG. 3, except that it includes an amplifier 38 that can be formed within the chip 12 or located off the chip. In operation, the amplifier receives and amplifies the optical input data 24 at wavelength λ1 before the optical input data is input to the first electro-absorption modulator 18.

An advantage of the wavelength converter 10 is that the first electro-absorption modulator 18, which is biased as a photodetector, and the second electro-absorption modulator 20, which is biased as a modulator, are made from same material and are configured in the same device structure. Therefore, the first and second electro-absorption modulators are almost identical devices, and as a result their impedances match one another. Another advantage associated with the wavelength converter is the optical-to-electronic and electronic-to-optical conversion is very efficient since the impedance of the first and second electro-absorption modulators is on the order of 1 kΩ. Because the electro-absorption modulators have a typical switching voltage on the order of 1.5 volts, the peak photocurrent in the detector required for driving the modulator is about 1.5 mA. Thus, for a typical detector implemented with an electro-absorption modulator and having a responsivity of 0.5 A/W, only 3 mW of peak optical power for the data is required for effective wavelength conversion. Because no electrical amplification is required, and no impedance matching circuitry is necessary, the resulting device is simple and low cost.

The amplifier 38 included in the embodiment in FIG. 6 of the wavelength converter 10 has the additional advantage of boosting the power of optical input data 24 at wavelength λ1 so that weak optical input signals can have their wavelengths efficiently converted.

Although exemplary embodiments of the present invention have been described, it should not be construed to limit the scope of the appended claims. Those skilled in the art understand that various modifications may be made to the described embodiments. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

I claim:

1. A wavelength converter, comprising:
a first electro-absorption modulator biased as a photodetector; and
a second electro-absorption modulator biased as a modulator electrically coupled to the first electro-absorption modulator.

2. The wavelength converter of claim 1, wherein the first electro-absorption modulator is electrically coupled to the second electro-absorption modulator by wire bonding.

3. The wavelength converter of claim 1, wherein the first electro-absorption modulator is electrically coupled to the second electro-absorption modulator via a coupling circuit.

4. The wavelength converter of claim 3, wherein the coupling circuit has the function of impedance matching, amplification, and filtering.

5. The wavelength converter of claim 1, wherein the impedance of the first electro-absorption modulator matches the impedance of the second electro-absorption modulator.

6. The wavelength converter of claim 5, wherein the impedance of the first electro-absorption modulator and the second electro-absorption modulator is approximately 1 kΩ.

7. The wavelength converter of claim 1, wherein the first electro-absorption modulator and second electro-absorption modulator are electrically connected in parallel between a voltage potential and ground potential.

8. The wavelength converter of claim 1, wherein the first electro-absorption modulator and the second electro-absorption modulator are electrically connected in series between a voltage potential and ground potential.

9. The wavelength converter of claim 1, wherein the first electro-absorption modulator and the second electro-absorption modulator are formed within a chip.

10. The wavelength converter of claim 1, further comprising a wave source optically coupled to the second electro-absorption modulator.

11. The wavelength converter of claim 10, wherein the wave source is tunable.

12. The wavelength converter of claim 10, wherein the first electro-absorption modulator converts optical input data at a first wavelength into an electrical signal, and the second electro-absorption modulator modulates a signal output from the wave source at a second wavelength with the electrical signal to generate a data signal at the second wavelength.

13. The wavelength converter of claim 10, wherein the first electro-absorption modulator, the second electro-absorption modulator, and the wave source are formed within a chip.

14. The wavelength converter of claim 1, further comprising an amplifier optically upstream from the first electro-absorption modulator.

15. The wavelength converter of claim 14, wherein the first electro-absorption modulator, the second electro-absorption modulator, and the amplifier are formed within a chip.

16. The wavelength converter of claim 14, further comprising a wave source optically coupled to the second electro-absorption modulator.

17. The wavelength converter of claim 16, wherein the first electro-absorption modulator, the second electro-absorption modulator, the amplifier, and the wave source are formed within a chip.

18. A method of wavelength conversion, comprising the steps of:
converting optical input data at a first wavelength into an electrical signal using a first electro-absorption modulator; and
modulating a signal output from a wave source at a second wavelength with the electrical signal using a second electro-absorption modulator to generate a data signal at the second wavelength.

19. The method of claim 18, further comprising the step of amplifying the optical input data before converting the optical input data into an electrical signal.
